(19) United States
(12) Patent Application Publication
(10) Pub. No.: US 2009/0267734 A1
(43) Pub. Date: Oct. 29, 2009

(54) MONITORING SYSTEM AND METHOD OF SMART KEY

(75) Inventor: Young Min Kwon, Seoul (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR)

(21) Appl. No.: 12/331,839

(22) Filed: Dec. 10, 2008

(30) Foreign Application Priority Data
Apr. 28, 2008 (KR) 10-2008-0039483

(51) Int. Cl. B60R 25/00

(52) U.S. Cl. 340/5.72

(57) ABSTRACT

A smart key monitoring system for a vehicle comprises: a first LF output antenna which transmits an authentication low frequency (LF) signal within a preset distance from a portion of one side of the vehicle; an RF receiver which is installed in a portion of the vehicle and receives an authentication response radio frequency (RF) signal generated by a smart key in response to the authentication LF signal; and a monitoring controller which performs the authentication of the authentication response RF signal received by the RF receiver, receives a request signal for unlocking a first door provided on one side of the vehicle for which the authentication succeeds from an unlock sensor of the first door, and delivers the unlock request signal to a door unlock controller.

### CROSS-REFERENCE TO RELATED APPLICATION

This application claims under 35 U.S.C. §119(a) the benefit of Korean Patent Application No. 10-2008-0039483 filed Apr. 28, 2008, the entire contents of which are incorporated herein by reference.

### BACKGROUND

The present disclosure relates to a system and method for monitoring a smart key for a vehicle, which can unlock a particular door or doors of the vehicle and keep the other doors locked after the smart key user is authenticated via wireless communication with the vehicle.

A conventional smart key monitoring system for a vehicle transmits an authentication low frequency (LF) signal to the smart key when the smart key approaches the vehicle. The smart key generates a radio frequency (RF) signal in response to the authentication LF signal and transmits the smart key monitoring system. The smart key monitoring system, which has received the authentication response RF signal, authenticates it. When the authentication succeeds and a driver or passenger contacts an outside handle of a door of the vehicle, the smart key monitoring system unlocks all doors of the vehicle. Alternatively, when the authentication succeeds and the driver or passenger presses a button provided on the outside handle, the smart key monitoring system unlocks all of the doors.

The smart key monitoring system, however, cannot selectively unlock a door or doors; it only can unlock all doors, which may cause the driver and passenger to be exposed to a theft or robbery.

The above information disclosed in this Background section is only for enhancement of understanding of the background of the invention and therefore it may contain information that does not form the prior art that is already known in this country to a person of ordinary skill in the art.

### SUMMARY

One of the objects of the present invention is to provide a smart key monitoring system and method for a vehicle that can selectively unlock a door or doors of the vehicle when a smart key is authenticated and a driver contacts the outside handle of a specific door.

In one aspect, the present invention provides a smart key monitoring system for a vehicle, comprising: a first LF output antenna which transmits an authentication low frequency (LF) signal within a preset distance from a portion of one side of the vehicle; an RF receiver which is installed in a portion of the vehicle and receives an authentication response radio frequency (RF) signal generated by a smart key in response to the authentication LF signal; and a monitoring controller which performs the authentication of the authentication response RF signal received by the RF receiver, receives a request signal for unlocking a first door provided on one side of the vehicle for which the authentication succeeds from an unlock sensor of the first door, and delivers the unlock request signal to a door unlock controller.

In another aspect, the present invention provides a smart key monitoring method, comprising the steps of: transmitting an authentication LF signal through a first LF output antenna installed at one side of a vehicle; receiving an authentication response RF signal generated by a smart key in response to the authentication LF signal; and delivering to a door unlock controller a request signal for unlocking a first door provided at the same side as the LF output antenna received from an unlock sensor of the first door, if the authentication response RF signal is authenticated and the unlock request signal is received within a preset time.

The present systems and methods can prevent a theft or robbery by allowing drivers/passengers to selectively open vehicle doors and improve security.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

FIG. 1 is a block diagram of a smart key monitoring system according to a preferred embodiment of the present invention.

FIG. 2 is a flowchart of a smart key monitoring method according to a preferred embodiment of the present invention.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

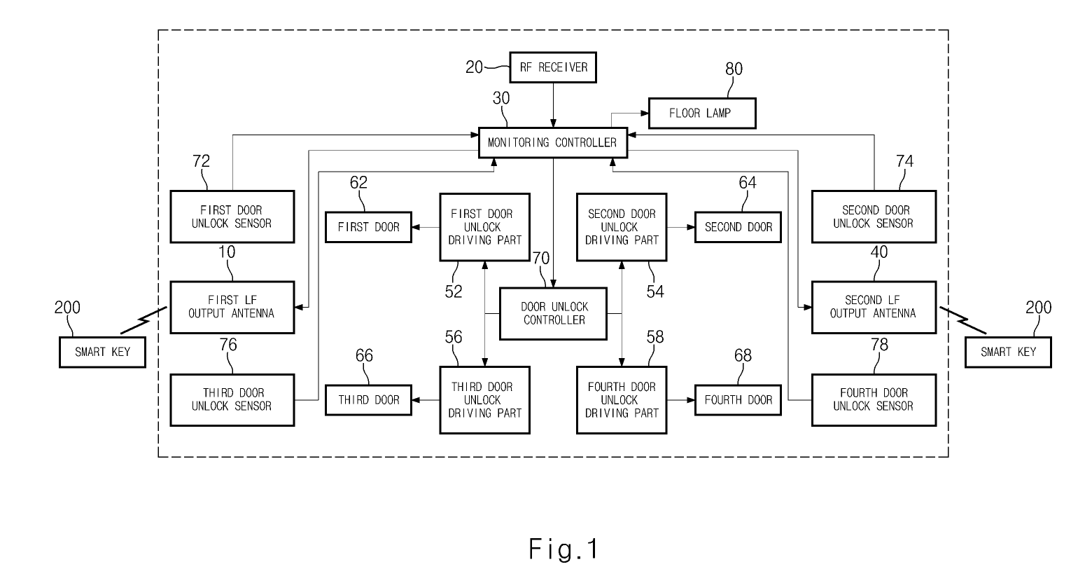

A smart key monitoring system according to an embodiment of the present invention will be explained with reference to FIG. 1.

As shown in FIG. 1, a first door 62 refers to a door provided near a driver's seat, a second door 64 refers to a door provided near a passenger seat in the first row, a third door 66 refers to a door provided near a passenger seat in the second row behind the driver's seat, and a fourth door 68 refers to a door provided near a passenger seat in the second row behind the passenger in the first row. Of course, in the case of a two-door vehicle, the third door 66 and the fourth door 68 will be omitted.

Here, the first to the fourth doors, 62, 64, 66, and 68 are provided with respective outside handles (door latches) including a first, a second, a third and a fourth door unlock sensors, 72, 74, 76, and 78 provided therein respectively. The first to the fourth door unlock sensors are, suitably, realized as a touch sensor (not shown) which senses the contact of a driver or passenger or a button (not shown) which senses the pressure applied by the driver or passenger.

A first to a fourth door unlock driving parts, 52, 54, 56, and 58, which function to unlock the first door 62 to the fourth door 68 respectively, are suitably provided. A door unlock controller 70 is suitably provided, which transmits an unlock request signal to the first to the fourth door unlock driving parts, 52, 54, 56, and 58.

The smart key monitoring system according to an embodiment of the present invention preferably includes a first LF output antenna 10, a RF receiver 20, a monitoring controller 30, and a second LF output antenna 40.

The first LF output antenna 10 is installed in the outside handle of the first door 62 to transmit a search LF signal and an authentication LF signal within a preset distance (for example, 1.2 m) from a portion of the left side of the vehicle.

The second LF output antenna 40 is installed in the outside handle of the second door 64 to transmit a search LF signal and an authentication LF signal with a preset distance (for example, 1.2 m) from a portion of the right side of the vehicle.

The RF receiver 20 is installed in a portion of the vehicle and receives a search response RF signal and an authentication response RF signal which have been generated by the smart key 200 in response to the search LF signal and the authentication LF signal respectively.

The monitoring controller 30 authenticates the authentication response RF signal the RF receiver 20 receives from the smart key 200. If the authentication succeeds, the monitoring controller 30 receives a request signal for unlocking the first door 62 from the unlock sensor 72 within a predetermined time. The monitoring controller 30 then delivers the unlock request signal to the door unlock controller 70. In an embodiment, when the authentication succeeds, the monitoring controller 30 may suitably turn on at least one of floor lamps of the vehicle.

On the other hand, if the authentication fails, the monitoring controller 30 controls the second LF output antenna 40 to transmit an authentication LF signal within a preset distance (e.g., 1.2 m) from a portion of the right side of vehicle.

Additionally, the monitoring controller 30 may suitably control the second LF output antenna 40 t0 transmit the authentication LF signal, if it receives an unlock request signal of the second door 64 from the unlock sensor 74 of the second door 64 within a predetermined time, not from the unlock sensor 72 of the first door 62.

Preferably, the monitoring controller 30 may include a database for the authentication of search response RF signals, and a database for the authentication of authentication response RF signals. Security can be enhanced by these two separate authentication processes. Various information can be stored in the search response RF signal and the authentication response RF signal. For example, the VIN number and plate number of the vehicle can be stored in the search response RF signal. The driver's name and license number can be stored in the authentication response RF signal.

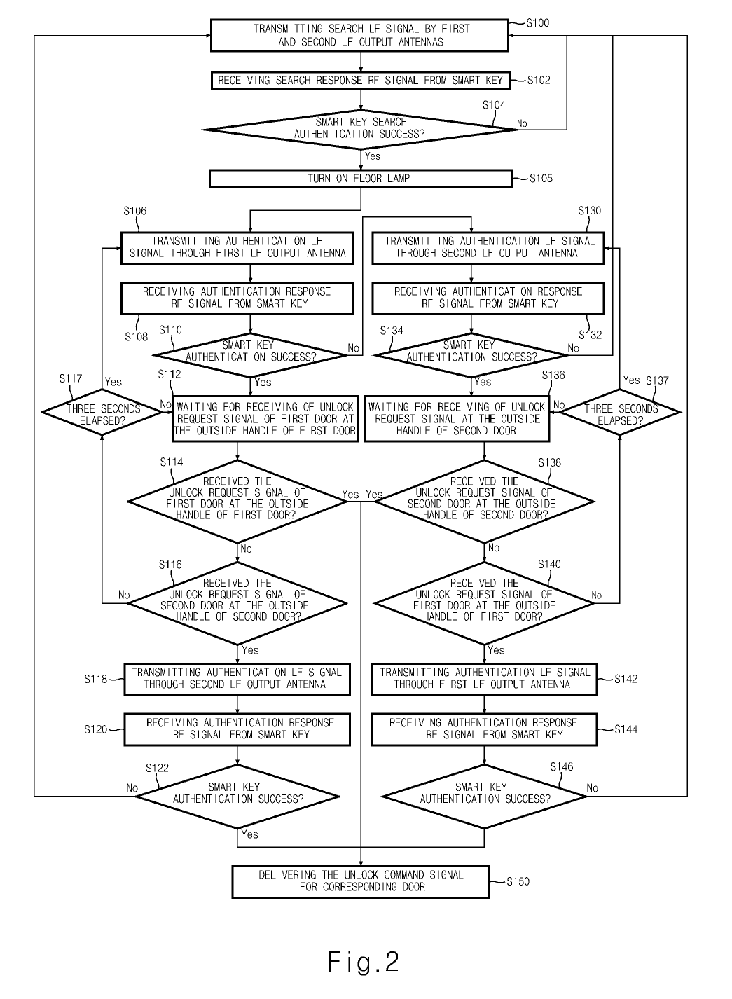

Hereinafter, a smart key monitoring method according to an embodiment of the present invention will be explained with reference to FIG. 2.

As shown in FIGS. 1 and 2, the monitoring controller 30 transmits search LF signals within a preset distance through the first and second LF output antennas 10, 40 (S100).

Then, the monitoring controller 30 receives through the RF receiver 20 a search response RF signal generated by the smart key 200 in response to at least one of the search LF signals (S102). The monitoring controller 30 performs the authentication of the search response RF signal (S104). The monitoring controller 30 may suitably turn on the floor lamp when the authentication of the search response RF signal succeeds (S105).

The monitoring controller 30 then transmits through the first LF output antenna 10 an authentication LF signal within a preset distance from a portion of the left side of the vehicle (S106).

Thereafter, the monitoring controller 30 receives through the RF receiver 20 an authentication response RF signal generated by the smart key 200 in response to the authentication LF signal (S108).

The monitoring controller 30 then performs the authentication of the authentication response RF signal (S110). If the authentication succeeds, the monitoring controller 30 waits for a predetermined time to receive a request signal for unlocking the first door 62 from the unlock sensor 72 (S112).

Subsequently, the monitoring controller 30 determines whether it has received the unlock request signal from the unlock sensor 72 (S114). If the monitoring controller 30 has received the unlock request signal from the unlock sensor 72, it delivers the unlock request signal to the door unlock controller 70 (S150).

On the other hand, if the monitoring controller 30 has not received the unlock request signal from the unlock sensor 72, it determines whether it has received a request signal for unlocking the second door 64 from the unlock sensor 74 (S116). If the monitoring controller 30 has not received the unlock request signal from the unlock sensor 74 within a preset time (e.g., 3 seconds), it returns to S106 (S119). If the monitoring controller 30 has received the unlock request signal from the unlock sensor 74, it transmits through the second LF output antenna 40 an authentication LF signal within a preset distance from a portion of the right side of the vehicle (S118).

If the monitoring controller 30 receives through the RF receiver 20 an authentication response RF signal generated by the smart key 200 in response to the authentication LF signal (S120), it performs the authentication of the authentication response RF signal (S122).

The monitoring controller 30 delivers to the door unlock controller 70 the unlock request signal received from the unlock sensor 74 when the authentication of the authentication response RF signal is successful (S150).

In the meantime, at S110, if the authentication of the authentication response RF signal fails, the monitoring controller 30 transmits through the second LF output antenna 40 an authentication LF signal within a preset distance from a portion of the right side of the vehicle (S130).

Then, the monitoring controller 30 receives through the RF receiver 20 an authentication response RF signal generated by the smart key 200 in response to the authentication LF signal (S132). Then, the monitoring controller 30 performs the authentication response RF signal (S134). When the authentication succeeds, the monitoring controller 30 waits to receive from the unlock sensor 74 a request signal for unlocking the second door 64 (S136).

The monitoring controller 30 determines whether it has received the unlock request signal from the unlock sensor 74 (S138). If the monitoring controller 30 has received the unlock request signal, it delivers the unlock request signal to the door unlock controller 70 (S150).

On the other hand, if the monitoring controller 30 has not received the unlock request signal, it determines whether the unlock sensor 72 of the first door 62 has received a request signal for unlocking the first door 62 (S140). If the unlock sensor 72 is unable to receive the unlock request signal within a preset time (e.g., 3 seconds), it turns back to S130 (S137). If, however, the monitoring controller 30 has received the unlock request signal from the unlock sensor 72, it transmits through the first LF output antenna 10 an authentication LF signal within a preset distance from a portion of the left side of the vehicle (S142).

When the monitoring controller 30 receives through the RF receiver 20 an authentication response RF signal generated by the smart key 200 in response to the authentication LF signal (S144), the monitoring controller 30 performs the authentication of the authentication response RF signal (S146).

If the authentication succeeds, the monitoring controller 30 delivers the unlock request signal for the first door 62 to the door unlock controller 70 (S150).

In the meantime, after getting in the vehicle by opening the first door 62, a driver can open the second door 64, the third door 66 and the fourth door 68, by manually controlling the door unlock controller 70 inside the vehicle.

As described above, the present systems and methods can be applied to a vehicle with two or more doors. In case of a four door vehicle, for example, when the authentication of an authentication response RF signal which has been generated by the smart key in response to an authentication LF signal transmitted by the first LF output antenna 10 is successful, a driver can selectively open either the first door 62 or the third door 66, which is arranged in the left side in which the authentication is successful.

That is, if the authentication of the authentication response RF signal is successful and the monitoring controller 30 receives a request signal for unlocking the first door 62 from the unlock sensor 72, the monitoring controller 30 delivers the unlock request signal to the door unlock controller 70. And, if the authentication of the authentication response RF signal is successful and the monitoring controller 30 receives a request signal for unlocking the third door 64 from the unlock sensor 76, the monitoring controller 30 delivers the unlock request signal to the door unlock controller 70.

Here, when the number of the door of vehicle increases, for example, 6, 8, 10, if the authentication of the left side (or the right side) is successful and the monitoring controller 30 receives a request signal for unlocking a particular door in the left side (or the right side) from the corresponding unlock sensor, the monitoring controller 30 delivers the unlock request signal to the door unlock controller 70, which can selectively unlock the particular door in the left side (or the right side).

It is to be understood that the present systems and methods can be applied to unlock trunk doors and bonnets of a vehicle, provided the number and positions of the components of the systems are appropriately adjusted, which is within the scope of the present invention.

It will be apparent to those skilled in the art that various modifications and variation can be made in the present invention without departing from the spirit or scope of the invention. Thus, it is intended that the present invention cover the modifications and variations of this invention, provided they come within the scope of the appended claims and their equivalents.

What is claimed is:

1. A smart key monitoring system for a vehicle, comprising:
a first LF output antenna which transmits an authentication low frequency (LF) signal within a preset distance from a portion of one side of the vehicle;
a RF receiver which is installed in a portion of the vehicle and receives an authentication response radio frequency (RF) signal generated by a smart key in response to the authentication LF signal; and
a monitoring controller which performs the authentication of the authentication response RF signal received by the RF receiver, receives a request signal for unlocking a first door provided on one side of the vehicle for which the authentication succeeds from an unlock sensor of the first door, and delivers the unlock request signal to a door unlock controller.

2. The smart key monitoring system of claim 1, further comprising a second LF output antenna which transmits an authentication LF signal within a preset distance of the other side of the vehicle,
wherein the monitoring controller transmits through the second LF output antenna the authentication LF signal within the preset distance of the other side of the vehicle, if the authentication of the authentication response RF signal fails of if the monitoring controller receives a request signal for unlocking a second door within a preset time from an unlock sensor of the second door.

3. The smart key monitoring system of claim 2, wherein, before the transmission of the authentication LF signals of the first and second LF output antennas, the monitoring controller transmits search LF signals through the first and second LF output antennas, receives through the RF receiver a search response RF signal generated by the smart key in response to at least one of the search LF signals, and performs the authentication of the search response RF signal.

4. The smart key monitoring system of claim 3, wherein the monitoring controller turns on a floor lamp of the vehicle when the authentication of the search response RF signal is successful.

5. The smart key monitoring system of claim 2, wherein if the monitoring controller receives the unlock request signal of the second door from the second door unlock sensor within a preset time after the success of the authentication of the authentication response RF signal, the monitoring controller transmits an authentication LF signal through the second LF output antenna, receives through the RF receiver an authentication response RF signal, and delivers the unlock request signal of for the second door to the door unlock controller.

6. The smart key monitoring system of claim 2, wherein, in case of transmitting the authentication LF signal through the second LF output antenna due to authentication failure of the authentication response RF signal, if the monitoring controller receives through the RF receiver the authentication response RF signal, the authentication of the authentication response RF signal succeeds, and the monitoring controller receives the unlock request signal from the second door unlock sensor, the monitoring controller delivers the unlock request signal to the door unlock controller.

7. The smart key monitoring system of claim 6, wherein, if the authentication of the authentication response RF signal succeeds and the monitoring controller receives a request signal for unlocking the first door from the first door unlock sensor within a preset time, the monitoring controller transmits an authentication LF signal through the first LF output antenna, receives an authentication response RF signal through the RF receiver, and delivers the unlock request signal for the first door to the door unlock controller.

8. The smart key monitoring system of claim 2, wherein the first door is a door provided near a driver's seat, the first LF output antenna is installed in the outside handle of the first door, the second door is a door provided near a passenger seat in the first row of the vehicle, and the second LF output antenna is installed in the outside handle of the second door.

9. The smart key monitoring system of claim 2, wherein if the authentication of one of the sides of the vehicle is successful and the monitoring controller receives a request signal for unlocking a particular door in that side from a corresponding unlock sensor, the monitoring controller delivers the unlock request signal to the door unlock controller, which can selectively unlock the particular door.

10. The smart key monitoring system of claim 2, wherein the first door is the trunk door of the vehicle, the first LF output antenna is installed in the outside handle of the trunk door, the second door is the bonnet of the vehicle, and the second LF output antenna is installed in the outside handle of the bonnet.

11. A smart key monitoring method, comprising the steps of:
(a) transmitting by a monitoring controller an authentication LF signal through a first LF output antenna installed at one side of a vehicle;
(b) receiving by the monitoring controller an authentication response RF signal generated by a smart key in response to the authentication LF signal through an RF receiver; and
(c) delivering by the monitoring controller to a door unlock controller a request signal for unlocking a first door provided at the same side as the LF output antenna received from an unlock sensor of the first door, if the authentication response RF signal is authenticated by the monitoring controller and the unlock request signal is received within a preset time by the monitoring controller.

12. The smart key monitoring method of claim 11, further comprising the step of transmitting by the monitoring controller the authentication LF signal through a second LF output antenna installed at the other side of the vehicle within a preset distance from a portion of the other side of the vehicle, if, at the step (c), the authentication of the authentication response RF signal fails, or if the monitoring controller receives a request signal for unlocking a second door from an unlock sensor of a second door provided at the same side as the second LF output antenna within a preset time.

13. The smart key monitoring method of claim 12, before the step of (a), further comprising the steps of:
(a-1) transmitting by the monitoring controller search LF signals through the first and second LF output antennas;
(a-2) receiving by the monitoring controller a search response RF signal generated by the smart key in response to at least one of the search LF signals through the RF receiver; and
(a-3) performing by the monitoring controller the authentication of the search response RF signal.
